(19) United States
(12) Patent Application Publication
(10) Pub. No.: US 2024/0295864 A1
(43) Pub. Date: Sep. 5, 2024

(54) METHODS, APPARATUS, AND ARTICLES OF MANUFACTURE TO MITIGATE UNINTENDED CONDITIONS IN SEMICONDUCTORS

(71) Applicant: Texas Instruments Incorporated, Dallas, TX (US)

(72) Inventors: Lokesh Kumar Botcha, Bangalore (IN); Abhijit Anant Patki, Bangalore (IN)

(21) Appl. No.: 18/216,224

(22) Filed: Jun. 29, 2023

(30) Foreign Application Priority Data
Mar. 1, 2023 (IN) 202341013720

(51) Int. Cl. G05B 19/18

(52) U.S. Cl. CPC G05B 19/188; G05B 2219/45031

(57) ABSTRACT

An example apparatus includes a register, a memory to store reconfiguration data associated with the register, and register control circuitry. The example register control circuitry is to determine whether the memory includes the reconfiguration data corresponding to a trigger event experienced by state machine circuitry. Additionally, the example register control circuitry is to, based on determining that the memory includes the reconfiguration data corresponding to the trigger event, reconfigure the register identified in the reconfiguration data with a value included in the reconfiguration data.

### CROSS-REFERENCE TO RELATED APPLICATION

This patent arises from a patent application that claims the benefit of and priority to Indian Patent Application No. 20/234,1013720, which was filed on Mar. 1, 2023, and is hereby incorporated herein by reference in its entirety.

### TECHNICAL FIELD

This description relates generally to troubleshooting and, more particularly, to methods, apparatus, and articles of manufacture to mitigate unintended conditions in semiconductors.

### BACKGROUND

Semiconductor developers test semiconductors after the semiconductors have been manufactured to validate whether the semiconductors have been manufactured and/or operate as expected and/or as intended. Such efforts are referred to as post-silicon validation. Post-silicon validation aids semiconductor development by allowing semiconductor developers to detect and redress one or more unintended and/or unexpected conditions in a semiconductor. For example, unintended conditions in a semiconductor include unintended system functions of the semiconductor, unintended electrical aspects of the semiconductor, and/or unintended systematic manufacturing defects in the semiconductor.

### SUMMARY

For methods, apparatus, and articles of manufacturing to mitigate unintended conditions in semiconductors, an example apparatus includes a register, a memory to store reconfiguration data associated with the register, and register control circuitry. The example register control circuitry is to determine whether the memory includes the reconfiguration data corresponding to a trigger event experienced by state machine circuitry. Additionally, the example register control circuitry is to, based on determining that the memory includes the reconfiguration data corresponding to the trigger event, reconfigure the register identified in the reconfiguration data with a value included in the reconfiguration data.

### BRIEF DESCRIPTION OF THE DRAWINGS

FIG. 1 is a block diagram of an example audio amplifier including example digital logic circuitry having example interface circuitry to mitigate unintended conditions in the audio amplifier.

FIG. 2 is a block diagram illustrating an example implementation of the interface circuitry of FIG. 1.

FIG. 3 is a block diagram illustrating an example topology of reconfiguration data stored in the memory of FIGS. 1 and 2.

FIG. 4 is a block diagram illustrating an example implementation of the register control circuitry of FIG. 2.

FIG. 5 is a flowchart representative of an example method to troubleshoot semiconductors.

FIG. 6 is a flowchart representative of example machine-readable instructions and/or example operations that may be executed, instantiated, and/or performed using an example programmable circuitry implementation of the register control circuitry of FIGS. 2 and/or 4.

FIG. 7 is a block diagram of an example processing platform including programmable circuitry structured to execute, instantiate, and/or perform the example machine-readable instructions and/or perform the example operations of FIG. 6 to implement the register control circuitry of FIGS. 2 and/or 4.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine-readable instructions of FIG. 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The same reference numbers or other reference designators are used in the drawings to designate the same or similar (functionally and/or structurally) features.

### DETAILED DESCRIPTION

The drawings of this patent are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Semiconductor developers utilize post-silicon validation to detect and redress unintended conditions (e.g., bugs, faults, errors, etc.) in semiconductors. For example, post-silicon validation may be utilized to detect and redress unintended conditions in a semiconductor that cannot otherwise be detected prior to manufacturing of the semiconductor. In post-silicon validation, if an unintended condition is detected, semiconductor developers attempt to troubleshoot the unintended condition to provide a corrective action that redresses the unintended condition. If semiconductor developers cannot provide a corrective action for an unintended condition in a semiconductor (e.g., there is an unintended condition in an internal state of the semiconductor), the semiconductor will be remanufactured (e.g., by repatterning silicon) to correct for the unintended condition.

Alternatively, if semiconductor developers are able to provide a corrective action for an unintended condition in a semiconductor, the semiconductor developers take the corrective action to redress the unintended condition. One technique to take a corrective action for an unintended condition in a semiconductor is to incorporate a change into a software driver for the semiconductor. For example, semiconductor developers define a script to redress the unintended condition and then update the software driver to communicate with the semiconductor to change a configuration of the semiconductor to correct the unintended condition. Such communication can take place according to the inter-integrated circuit (I2C) protocol, the serial peripheral interface (SPI) protocol, and/or any other communication protocol.

However, making configuration changes via communication protocol-based scripts complicates development and/or integration of software driver(s). Additionally, making configuration changes via communication protocol-based scripts requires additional operation of the software driver(s) on end-user devices which increases the measure of million instructions per second (MIPS) on the end-user devices. Furthermore, making configuration changes via communication protocol-based scripts requires exposure of hidden register configurations to end-users. For example, a communication protocol-based script may reprogram a hidden test mode register of a semiconductor. In such an example, to implement the communication protocol-based script, a semiconductor developer may need to provide information to the end-user concerning the hidden test mode register configuration. Moreover, making configuration changes via communication protocol-based scripts requires revealing unintended conditions to end-users of semiconductor products. As such, customer confidence in the robustness of semiconductor products can be decreased.

Examples described herein improve troubleshooting of unintended conditions in semiconductors. For examples, examples described herein include reserving a portion of memory (e.g., one-time programmable (OTP) memory) to store data to correct unintended conditions in semiconductors. As such, examples described herein allow for configuration changes to be made without communicating the existence of unintended conditions to end-users of semiconductor products. Additionally, examples described herein provide improved flexibility to adjust (e.g., update) any internal configuration of a semiconductor.

Examples described herein also include controlling the timing of configuration changes. For example, examples described herein can change configurations during semiconductor device power up, semiconductor device power down, among others. As such, examples described herein can achieve complex corrective actions which reduces the probability of requiring repatterning of silicon. Such complex corrective actions would not otherwise be possible without examples described herein. Additionally, control of the timing of configuration changes would not otherwise be possible without examples disclosed herein.

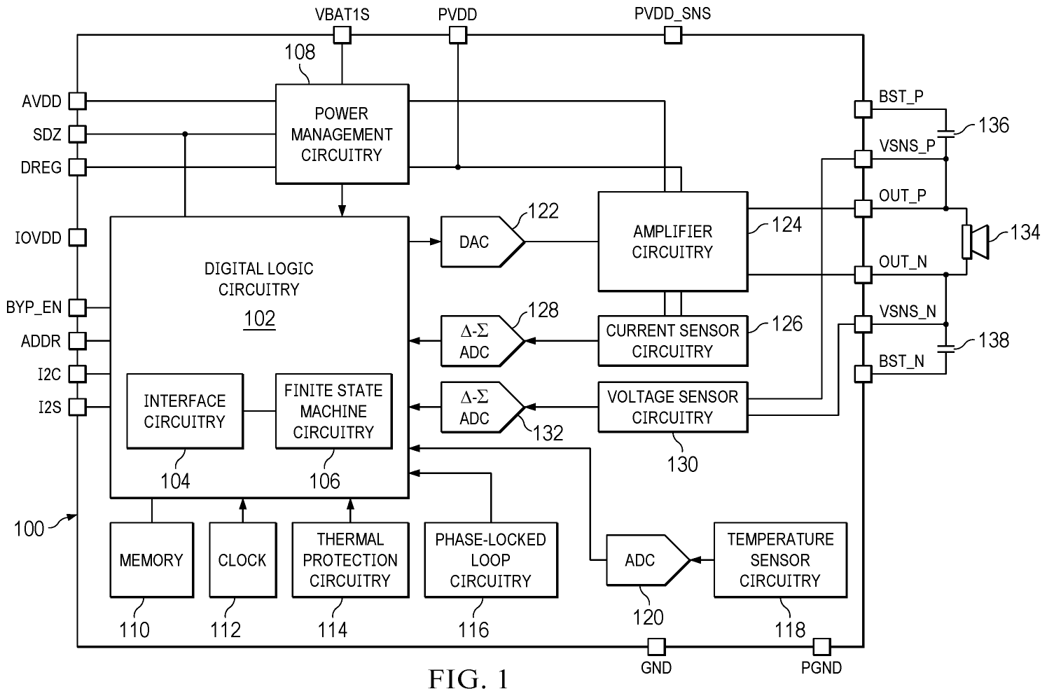

FIG. 1 is a block diagram of an example audio amplifier 100 including example digital logic circuitry 102 having example interface circuitry 104 to mitigate unintended conditions in the audio amplifier 100. In the example of FIG. 1, the example digital logic circuitry 102 of the audio amplifier 100 includes the example interface circuitry 104 and example finite state machine (FSM) circuitry 106. In the example of FIG. 1, the audio amplifier 100 also includes example power management circuitry 108, example memory 110, an example clock 112, example thermal protection circuitry 114, example phase-locked loop (PLL) circuitry 116, example temperature sensor circuitry 118, a first example analog to digital converter (ADC) 120, an example digital to analog converter (DAC) 122, example amplifier circuitry 124, example current sensor circuitry 126, a second example ADC 128, example voltage sensor circuitry 130, and a third example ADC 132. In the example of FIG. 1, the audio amplifier 100 is coupled to an example audio output device 134, a first example capacitor 136, and a second example capacitor 138. In the example of FIG. 1, the digital logic circuitry 102 also includes example audio filters, example serial interface circuitry, example voltage limiter circuitry, and example noise gate circuitry. In the example of FIG. 1, the ADC 100 also includes analog circuitry such as electrostatic discharge (ESD) protection circuitry, level shifters, among others.

In the illustrated example of FIG. 1, the interface circuitry 104 controls communication between the audio amplifier 100 and another device (e.g., a microcontroller unit (MCU)). For example, the interface circuitry 104 includes address detection logic circuitry, digital input/output (I/O) logic circuitry, and one or more registers. For example, the one or more registers may store configuration values to configure and/or trim (e.g., adjust) settings of components of the audio amplifier 100. Example settings include audio filter settings, audio output (e.g., volume) settings, voltage limiter settings, noise gate settings, current sensor settings, voltage sensor settings, among others.

In the illustrated example of FIG. 1, the digital I/O logic circuitry includes communication protocol circuitry, register control circuitry, and arbitration circuitry. The example communication protocol circuitry controls communication between the audio amplifier 100 and other devices. For example, an MCU may communicate with the communication protocol circuitry to set a value to configure (e.g., to adjust an audio filter of) the audio amplifier 100 for a particular application. In the example of FIG. 1, the register control circuitry controls configuration changes to the one or more registers and/or other reconfigurable circuitry to mitigate unintended conditions in the audio amplifier 100. For example, the register control circuitry utilizes reconfiguration data stored in the memory 110 to change configurations via the one or more registers and/or other reconfigurable circuitry.

In the illustrated example of FIG. 1, the FSM circuitry 106 controls internal operation of the audio amplifier 100. For example, the FSM circuitry 106 monitors an audio input signal to determine whether to power down/power up the amplifier circuitry 124 to reduce undesirable output audio from the audio output device 134. Additionally, the FSM circuitry 106 controls the amplifier circuitry 124 to reduce distortion and controls the power management circuitry 108 to prevent brownout events. In the example of FIG. 1, the power management circuitry 108 includes one or more low dropout regulators to generate reference voltages for components on the audio amplifier 100. For example, the power management circuitry 108 provides power to the digital logic circuitry 102. Additionally, the power management circuitry 108 provides power to the amplifier circuitry 124. The power management circuitry 108 also supplies one or more reference voltages and/or one or more bias currents to components on the audio amplifier 100.

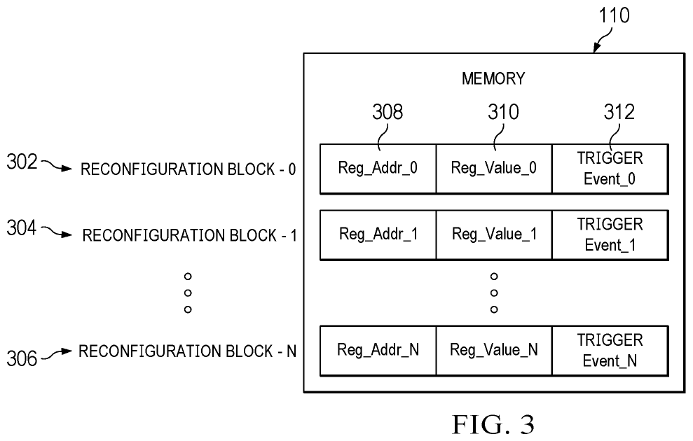

In the illustrated example of FIG. 1, the memory 110 includes OTP memory (one-time programmable memory) storing reconfiguration data. The memory 110 is described in further detail in connection with FIG. 3. In the example of FIG. 1, the clock 112 provides a clock signal that can be utilized, in addition to or in the alternative of the signal output by the PLL circuitry 116, by components of the audio amplifier 100 (e.g., the digital logic circuitry 102). In the example of FIG. 1, the clock 112 is implemented by a crystal oscillator. In the example of FIG. 1, the thermal protection circuitry 114 limits the audio signal output by the amplifier circuitry 124 when the temperature of the semiconductor die implementing the audio amplifier 100 satisfies a threshold. For example, when the temperature of the semiconductor die implementing the audio amplifier 100 satisfies the threshold, the thermal protection circuitry 114 communicates with the digital logic circuitry 102 to shut down the amplifier circuitry 124. In the example of FIG. 1, the PLL circuitry 116 is implemented by a phase locked loop oscillator. In the example of FIG. 1, the signal generated by the PLL circuitry 116 can be utilized, in addition to or in the alternative of the clock signal generated by the clock 112, by components of the audio amplifier 100 (e.g., the digital logic circuitry 102).

In the illustrated example of FIG. 1, the temperature sensor circuitry 118 monitors the temperature of the semiconductor die implementing the audio amplifier 100 and communicates data representing the temperature of the semiconductor die to the digital logic circuitry 102 via the first ADC 120. In the example of FIG. 1, the digital logic circuitry 102 communicates the digital audio signal input to the audio amplifier 100 to the DAC 122 which converts the digital audio signal into and an analog audio signal and provides the analog audio signal to the amplifier circuitry 124. In the example of FIG. 1, the amplifier circuitry 124 is implemented by a class-D amplifier. For example, the amplifier circuitry 124 includes a loop filter and a 16 volt (V) laterally-diffused metal-oxide semiconductor (LDMOS) output stage. Additionally, the analog audio signal input to the amplifier circuitry 124 may be compared to a referenced value via a comparator included in the amplifier circuitry 124. The amplified signal generated by the amplifier circuitry 124 is then provided to the audio output device 134.

In the illustrated example of FIG. 1, the current sensor circuitry 126 monitors the current flowing through the amplifier circuitry 124 and communicates data representing the current flowing through the amplifier circuitry 124 to the digital logic circuitry 102 via the second ADC 128. In the example of FIG. 1, the voltage sensor circuitry 130 monitors the voltage across the audio output device 134 and communicates data representing the voltage across the audio output device 134 to the digital logic circuitry 102 via the third ADC 132.

In the illustrated example of FIG. 1, the audio output device 134 is implemented by a speaker coupled to the output of the amplifier circuitry 124. In the example of FIG. 1, the first capacitor 136 and the second capacitor 138 operate as positive and negative bootstrap capacitors, respectively. For example, the first capacitor 136 and the second capacitor 138 charge up to provide the requisite voltage between the gate and source (or gate and drain) of the LDMOS transistors implemented in the output stage of the amplifier circuitry 124. While FIG. 1 illustrates an example audio amplifier, examples discussed herein may be implemented with additional or alternative example circuitry. For example, examples discussed herein may be implemented with additional or alternative audio amplifiers. Furthermore, examples discussed herein may be implemented with other circuitry such as microcontroller circuitry and/or other programmable circuitry, audio devices, motor driver circuitry, power management circuitry, among others.

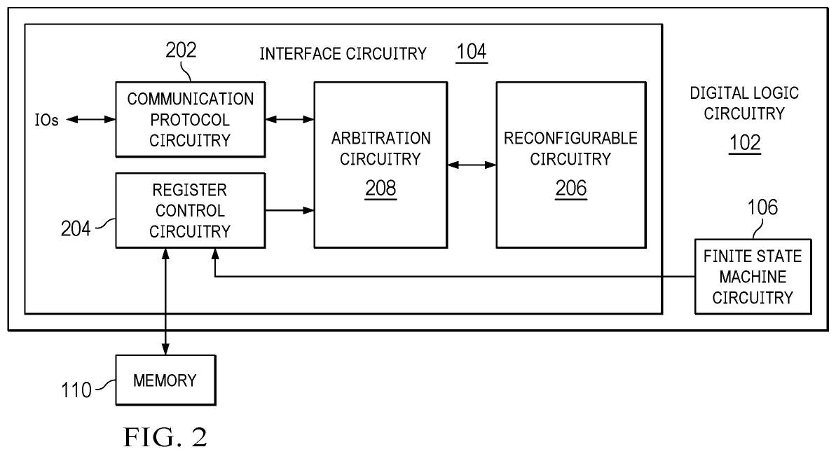

FIG. 2 is a block diagram illustrating an example implementation of the interface circuitry 104 of FIG. 1. In the example of FIG. 2, the interface circuitry 104 includes example communication protocol circuitry 202, example register control circuitry 204, example reconfigurable circuitry 206, and example arbitration circuitry 208. The interface circuitry 104 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the interface circuitry 104 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the communication protocol circuitry 202 is coupled to the arbitration circuitry 208 and example inputs and outputs of the audio amplifier 100 (e.g., the I2C port of the audio amplifier 100). In the example of FIG. 2, the communication protocol circuitry 202 can be implemented according to any communication protocol. For example, the communication protocol circuitry 202 is compatible with the I2C protocol, the SPI protocol, among others. In the example of FIG. 2, the communication protocol circuitry 202 controls communication between the audio amplifier 100 and other devices. For example, an MCU may communicate a value to the communication protocol circuitry 202 to set a configuration parameter for an internal component (e.g., an audio filter) of the audio amplifier 100 for a particular application. The communication protocol circuitry 202 determines the value according to the communication protocol and communicates the value to the arbitration circuitry 208. Generally, such setting of configuration parameters for internal components of the audio amplifier 100 occurs shortly after power up of the audio amplifier 100.

In the illustrated example of FIG. 2, the register control circuitry 204 is coupled to the FSM circuitry 106, the memory 110, and the arbitration circuitry 208. In the example of FIG. 2, the register control circuitry 204 controls configuration changes to the reconfigurable circuitry 206 to mitigate unintended conditions in the audio amplifier 100. For example, the reconfigurable circuitry 206 includes one or more device configuration registers. In the example of FIG. 2, the register control circuitry 204 utilizes reconfiguration data stored in the memory 110 to change configurations via one or more registers of the reconfigurable circuitry 206. In the example of FIG. 2, the register control circuitry 204 monitors the FSM circuitry 106 of the digital logic circuitry 102 to determine whether the FSM circuitry 106 has experienced (e.g., undergone) a trigger event. Based on the FSM circuitry 106 experiencing (e.g., undergoing) a trigger event, the register control circuitry 204 determines whether the memory 110 includes reconfiguration data corresponding to the trigger event (e.g., whether the memory includes reconfiguration data corresponding to the trigger event). Based on the reconfiguration data stored in the memory 110, the register control circuitry 204 updates, reprograms, and/or otherwise adjusts a register of the reconfigurable circuitry 206 to mitigate an unintended condition in the audio amplifier 100.

In the illustrated example of FIG. 2, the memory 110 is coupled to the register control circuitry 204. In the example of FIG. 2, the memory 110 is implemented by OTP memory. In the example of FIG. 2, a portion of the memory 110 is reserved by developers of the audio amplifier 100 for reconfiguration data (e.g., one or more post-silicon repurposing blocks). For example, the reconfiguration data is loaded into the memory 110 by developers of the audio amplifier 100 prior to deployment of the audio amplifier 100. In some examples, the reconfiguration data is loaded into the memory 110 by a software driver of the audio amplifier 100 during the initial boot sequence of the audio amplifier 100. FIG. 3 is a block diagram illustrating an example topology of reconfiguration data stored in the memory 110 of FIGS. 1 and 2. Example reconfiguration data stored in the memory 110 may be divided into one or more reconfiguration blocks of data. In the example of FIG. 3, the reconfiguration data stored in the memory 110 is divided into N reconfiguration blocks. For example, the memory 110 includes a first example reconfiguration block 302 (e.g., reconfiguration block-0), a second example reconfiguration block 304 (e.g., reconfiguration block-1), and an Nth example reconfiguration block 306 (e.g., reconfiguration block-N). Each reconfiguration block can be utilized by the register control circuitry 204 of FIG. 2 to reprogram a device configuration stored in a register of the reconfigurable circuitry 206. In the example of FIG. 3, a reconfiguration block includes data (e.g., reconfiguration data) identifying an address of a register to be reprogrammed, a value with which the register is to be programmed (e.g., reprogrammed), and a trigger event to which the reconfiguration block corresponds.

For example, the first reconfiguration block 302 includes example register address data 308, example register value data 310, and example trigger event data 312. In the example of FIG. 3, design of the portion of the memory 110 that is reserved for reconfiguration data is based on the number of reconfiguration blocks to be included in the memory 110, the width of register addresses of registers of the reconfigurable circuitry 206, the width of register values to be stored in the memory 110, and the number of trigger events to be supported by the register control circuitry 204. In the example of FIG. 3, the register address data 308 identifies an address of the register that is to be reprogrammed to perform the configuration change associated with the first reconfiguration block 302.

In the illustrated example of FIG. 3, the width of register address data field (e.g., the register address data 308) can be adjusted to accommodate the number of registers in the reconfigurable circuitry 206. For example, the width of register address data field (e.g., the register address data 308) can be increased to accommodate more registers in the reconfigurable circuitry 206 or decreased to accommodate less registers in the reconfigurable circuitry 206. Additionally, for example, the width of register address data field (e.g., the register address data 308) can be increased to accommodate more configuration changes (e.g., more registers of the reconfigurable circuitry 206 that are to be reprogrammed) or decreased to accommodate less configuration changes (e.g., less registers of the reconfigurable circuitry 206 that are to be reprogrammed).

In the illustrated example of FIG. 3, the example register value data 310 identifies the value (e.g., the bit code) with which a register is to be reprogrammed. In the example of FIG. 3, the width of register value data field (e.g., the register value data 310) can be increased or decreased depending on the data size of register values stored in registers of the reconfigurable circuitry 206. For example, if register values stored in registers of the reconfigurable circuitry 206 are 2-bit values, then the width of register value data field (e.g., the register value data 310) will be 2-bits. Additionally or alternatively, if register values stored in registers of the reconfigurable circuitry 206 are 1-bit values, then the width of register value data field (e.g., the register value data 310) will be 1-bits.

In the illustrated example of FIG. 3, the trigger event data 312 can identify one or more codes (e.g., one or more trigger codes) that corresponds to one or more device states (e.g., one or more states of the audio amplifier 100) after which the reconfiguration of the register is to take place. For example, a corrective action for an unintended condition in a semiconductor device may require a configuration update to occur shortly before the semiconductor device is fully powered up. Additionally or alternatively, a corrective action for an unintended condition in the semiconductor device may require a configuration update to occur shortly after the semiconductor device begins powering down. As such, the data identifying the trigger event (e.g., the trigger event code) differentiates the timing of configuration updates identified in reconfiguration blocks. For example, in some examples, the trigger event data field (e.g., the trigger event data 312) identifies a time at which the register control circuitry 204 is to reconfigure a corresponding register.

In the illustrated example of FIG. 3, the trigger event data 312 identifies one trigger event that is to cause the register control circuitry 204 to reprogram a register. In additional or alternative examples, the trigger event data 312 identifies multiple trigger events that are to cause the register control circuitry 204 to reprogram a register. For example, the trigger event data 312 may include a first trigger code (e.g., 000) that corresponds to programming the register identified by the register address data 308 just before power up of the audio amplifier 100. Additionally, for example, the trigger event data 312 may include a second trigger code (e.g., 001) that corresponds to programming the register identified by the register address data 308 just after power up of the audio amplifier 100. Example trigger event codes described herein are predefined during semiconductor development. As such, example trigger events described herein include predefined trigger events.

In some examples, the topology of reconfiguration data stored in the memory 110 is implemented differently. For example, the memory 110 includes N reconfiguration blocks and a separate section that includes M trigger event blocks. In such an example, each reconfiguration block includes register address data and register value data. Additionally, in such an example, each trigger event block includes a trigger event code and data identifying the number of reconfiguration blocks corresponding to the trigger event code. In such examples, the N reconfiguration blocks are organized in an order corresponding to the M trigger event blocks. For example, a first trigger event block includes data identifying two reconfiguration blocks corresponding to a first trigger event code and a second trigger event block includes data identifying three reconfiguration blocks corresponding to a second trigger event code. As such, the first trigger event block indicates that a reconfiguration block ordered first (e.g., according to address) in the memory 110 and a reconfiguration block ordered second in the memory 110 are to utilized to reprogram respective registers when the first trigger event code is detected. Additionally, the second trigger event block indicates that a reconfiguration block ordered third in the memory 110, a reconfiguration block ordered fourth in the memory 110, and a reconfiguration block ordered fifth in the memory 110 are to be utilized to reprogram respective registers when the second trigger event code is detected. Such an example topology of reconfiguration data in the memory 110 is more efficient (e.g., requires less bits).

Returning to FIG. 2, the reconfigurable circuitry 206 is coupled to the arbitration circuitry 208. In the example of FIG. 2, the reconfigurable circuitry 206 is implemented by one or more hardware registers. For example, the one or more hardware registers include one or more flip flop circuits. In additional or alternative examples, the reconfigurable circuitry 206 is implemented by memory (e.g., volatile memory), a variable component (e.g., a rheostat, a potentiometer, a trimmable potentiometer, a thermistor, a humistor, a photoresistor, a memristor, a voltage-dependent resistor, a tuning capacitor, a trimmer capacitor, a vacuum variable capacitor, a variable inductor, a trimmable inductor, etc.) including a register, a variable component including switching circuitry, among others. For example, an amplifier including a variable gain network also includes switching circuitry which may be adjusted to adjust the gain of the amplifier. In the example of FIG. 2, the one or more registers of the reconfigurable circuitry 206 store configuration values (e.g., configuration parameters, configuration settings, etc.) for the audio amplifier 100. Example configuration values include audio filter configurations, audio output (e.g., volume) configurations, voltage limiter configurations, noise gate configurations, current sensor configurations, voltage sensor configurations, among others.

In the illustrated example of FIG. 2, the arbitration circuitry 208 is coupled to the communication protocol circuitry 202, the register control circuitry 204, and the reconfigurable circuitry 206. In the example of FIG. 2, the arbitration circuitry 208 is implemented by asynchronous arbitration circuitry. Additionally or alternatively, the arbitration circuitry 208 is implemented by synchronous arbitration circuitry. As described above, an MCU may communicate a value to the communication protocol circuitry 202 to set a configuration parameter for an internal component (e.g., an audio filter) of the audio amplifier 100. Such communication usually occurs as part of an initialization script communicated to the audio amplifier 100 by a software driver for the audio amplifier 100. Additionally, as described above, the register control circuitry 204 programs (e.g., reprograms) one or more registers of the reconfigurable circuitry 206 to mitigate unintended conditions of the audio amplifier 100 identified during post-silicon validation. In the example of FIG. 2, the arbitration circuitry 208 resolves race conditions occurring between the communication protocol circuitry 202 and the register control circuitry 204.

For example, the arbitration circuitry 208 handles competing (e.g., conflicting) configuration change requests between the communication protocol circuitry 202 and the register control circuitry 204 based on a priority of the configuration change requests. In the example of FIG. 2, configuration change requests from the communication protocol circuitry 202 are given a higher priority than configuration change requests from the register control circuitry 204. In additional or alternative examples, configuration change requests from the register control circuitry 204 may be given a higher priority than configuration change requests from the communication protocol circuitry 202.

In the illustrated example of FIG. 2, the FSM circuitry 106 is coupled to the register control circuitry 204. In the example of FIG. 2, the FSM circuitry 106 is instantiated to generate alerts (e.g., interrupts) when the audio amplifier 100 experiences (e.g., undergoes) a trigger event). For example, when the FSM circuitry 106 experiences a trigger event for the audio amplifier 100, the FSM circuitry 106 generates an interrupt (e.g., an interrupt including a trigger event code identify the type of interrupt) that is communicated to the register control circuitry 204. Based on the interrupt, the register control circuitry 204 determines an address of a register to be reprogrammed and a value with which to reprogram the register based on reconfiguration data stored in the memory 110. As described above, the reconfiguration data is stored in the memory 110 to identify the configuration changes to be implemented to mitigate an unintended condition in the audio amplifier 100 and the timing (e.g., trigger event) for when to implement the configuration changes.

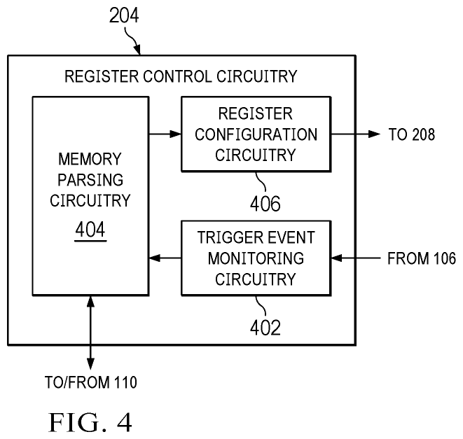

FIG. 4 is a block diagram illustrating an example implementation of the register control circuitry 204 of FIG. 2. In the example of FIG. 4, the register control circuitry 204 includes example trigger event monitoring circuitry 402, example memory parsing circuitry 404, and example register configuration circuitry 406. The register control circuitry 204 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the register control circuitry 204 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

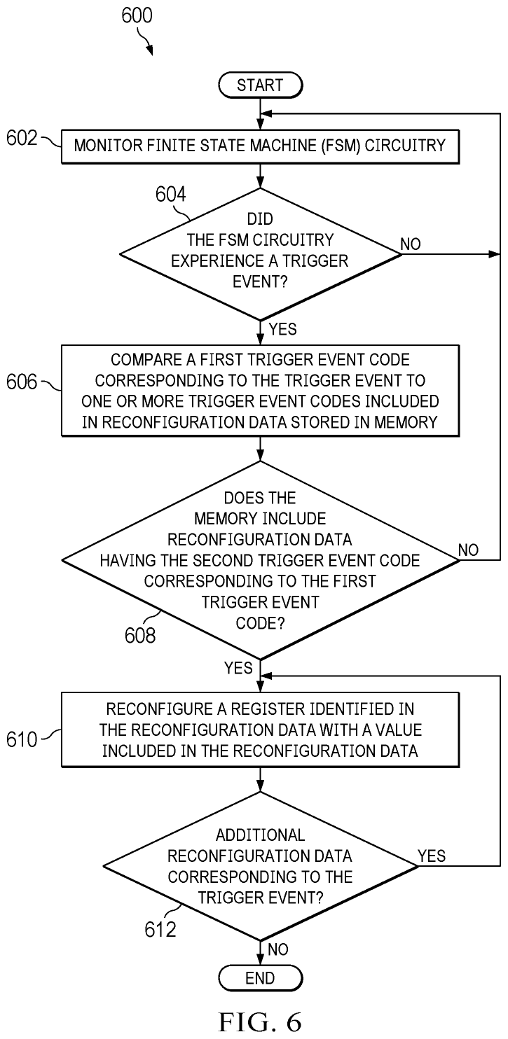

In the illustrated example of FIG. 4, the trigger event monitoring circuitry 402 is coupled to the FSM circuitry 106 of FIGS. 1 and/or 2 and the memory parsing circuitry 404 of FIG. 4. In the example of FIG. 4, the trigger event monitoring circuitry 402 monitors the FSM circuitry 106 to determine whether the FSM circuitry 106 has experienced (e.g., undergone) a trigger event. For example, the trigger event monitoring circuitry 402 determines whether an interrupt has been received from the FSM circuitry 106. Based on the FSM circuitry 106 experiencing (e.g., undergoing) a trigger event, the trigger event monitoring circuitry 402 notifies the memory parsing circuitry 404 that the FSM circuitry 106 has experienced the trigger event. For example, the trigger event monitoring circuitry 402 extracts a trigger event code from the interrupt and forwards the trigger event code to the memory parsing circuitry 404. In some examples, the trigger event monitoring circuitry 402 is instantiated by programmable circuitry executing trigger event monitoring instructions and/or configured to perform operations such as those represented by the flowchart(s) of FIG. 6.

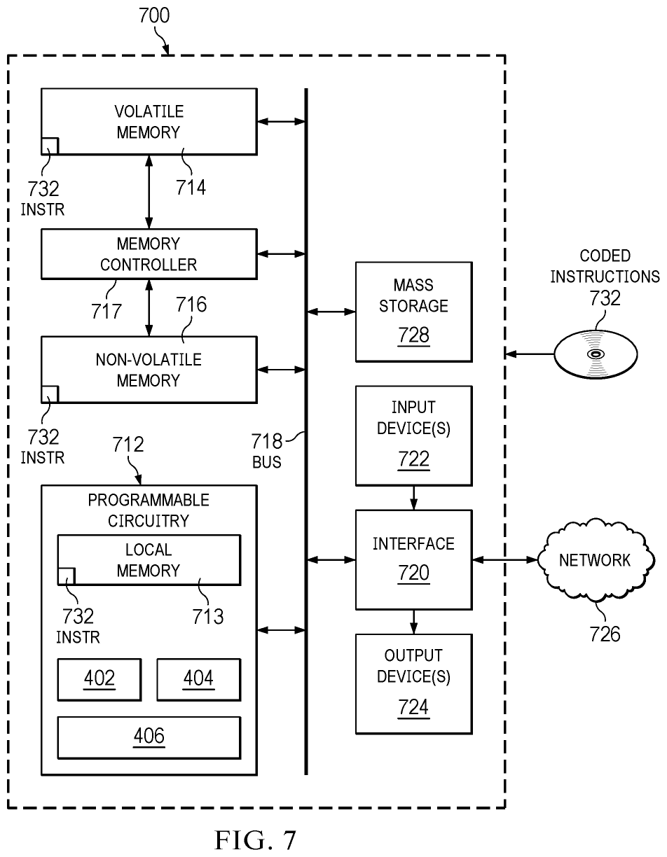

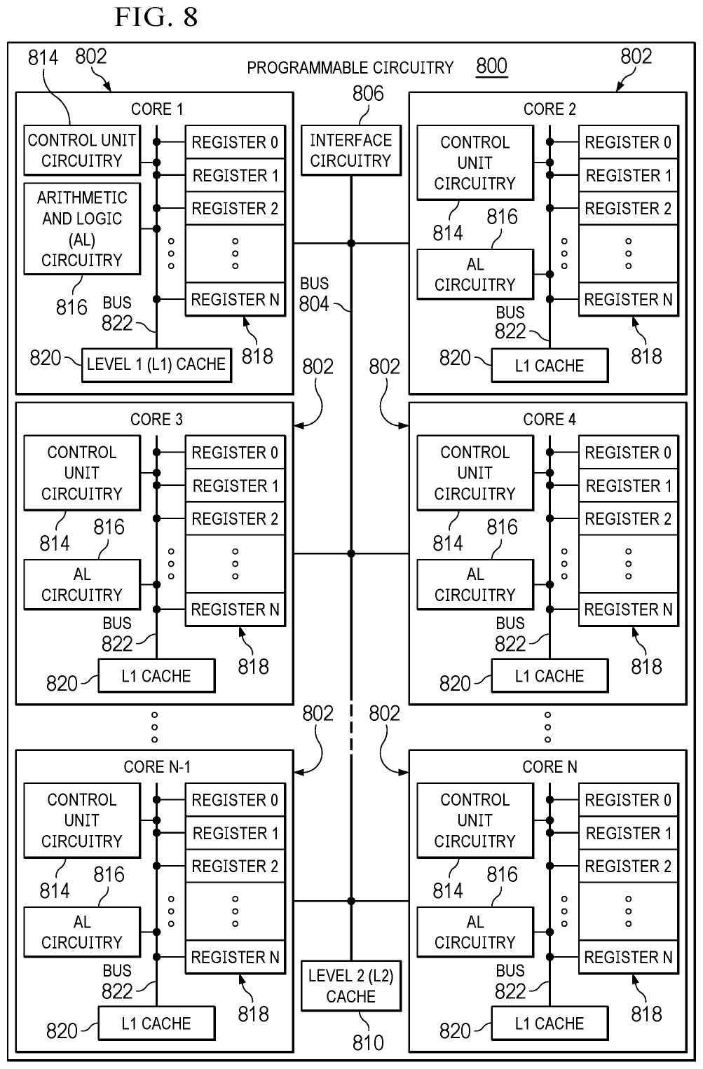

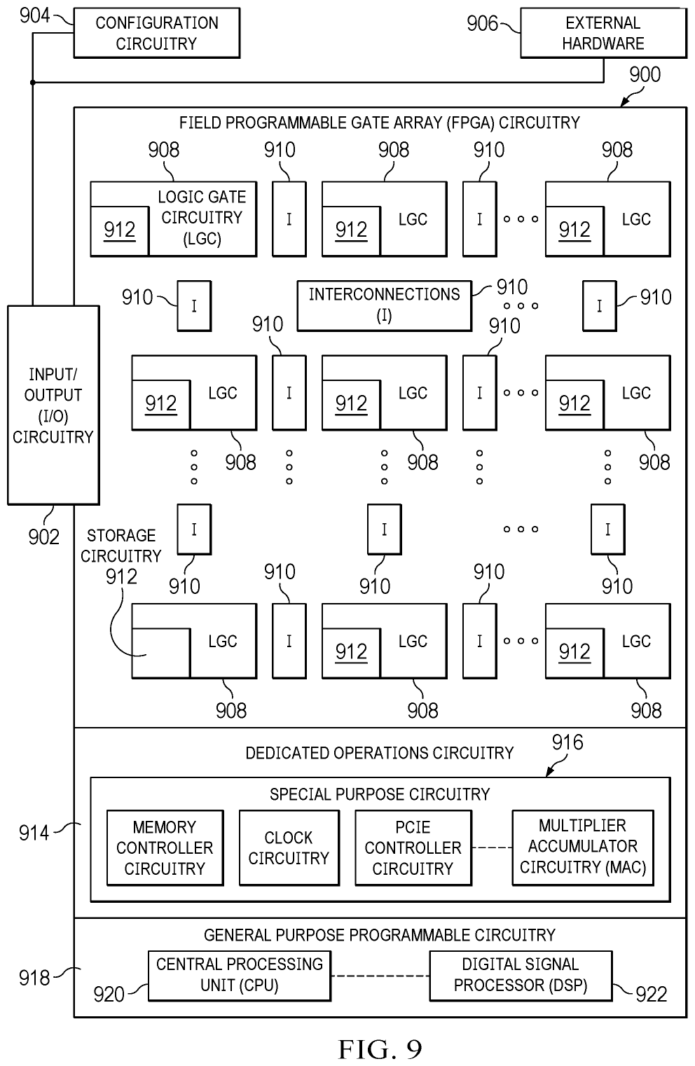

In some examples, the register control circuitry 204 includes means for monitoring trigger events. For example, the means for monitoring trigger events may be implemented by the trigger event monitoring circuitry 402. In some examples, the trigger event monitoring circuitry 402 may be instantiated by programmable circuitry such as the example programmable circuitry 712 of FIG. 7. For example, the trigger event monitoring circuitry 402 may be instantiated by the example microprocessor 800 of FIG. 8 executing machine-executable instructions such as those implemented by at least blocks 602 and 604 of FIG. 6. In some examples, the trigger event monitoring circuitry 402 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the trigger event monitoring circuitry 402 may be instantiated by any other combination of hardware, software, and/or firmware. For example, the trigger event monitoring circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 4, the memory parsing circuitry 404 is coupled to the memory 110 of FIGS. 1 and/or 2, the trigger event monitoring circuitry 402 of FIG. 4, and the register configuration circuitry 406 of FIG. 4. In the example of FIG. 4, the memory parsing circuitry 404 determines whether the memory 110 includes reconfiguration data corresponding to the trigger event. For example, the memory parsing circuitry 404 parses the memory 110 to determine whether the memory 110 includes a reconfiguration block having a trigger event code that matches the trigger event code received from the FSM circuitry 106. Based on determining that the memory 110 includes a reconfiguration block having a trigger event code that matches the received trigger event code, the memory parsing circuitry 404 determine the register address data and the register value data included in the reconfiguration block. Additionally or alternatively, the memory parsing circuitry 404 parses the memory 110 to determine whether the memory 110 includes a trigger event block having a trigger event code that matches the trigger event code received from the FSM circuitry 106. Based on determining that the memory 110 includes a trigger event block having a trigger event code that matches the received trigger event code, the memory parsing circuitry 404 determines the number and position of reconfiguration block(s) corresponding to the trigger event code in the memory 110. Additionally, the memory parsing circuitry 404 extracts the register address data and the register value data included in the corresponding reconfiguration block(s). In the example of FIG. 4, the memory parsing circuitry 404 forwards the register address data and register value data to the register configuration circuitry 406. In some examples, the memory parsing circuitry 404 is instantiated by programmable circuitry executing memory parsing instructions and/or configured to perform operations such as those represented by the flowchart(s) of FIG. 6.

In some examples, the register control circuitry 204 includes means for parsing memory. For example, the means for parsing memory may be implemented by the memory parsing circuitry 404. In some examples, the memory parsing circuitry 404 may be instantiated by programmable circuitry such as the example programmable circuitry 712 of FIG. 7. For example, the memory parsing circuitry 404 may be instantiated by the example microprocessor 800 of FIG. 8 executing machine-executable instructions such as those implemented by at least blocks 606, 608, and 612 of FIG. 6. In some examples, the memory parsing circuitry 404 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the memory parsing circuitry 404 may be instantiated by any other combination of hardware, software, and/or firmware. For example, the memory parsing circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 4, the register configuration circuitry 406 is coupled to the arbitration circuitry 208 of FIG. 2 and the memory parsing circuitry 404 of FIG. 4. In the example of FIG. 4, the register configuration circuitry 406 determines the address of a register that is to be programmed and a value with which to program the register. For example, the register configuration circuitry 406 determines the address of a register that is to be programmed based on register address data received from the memory parsing circuitry 404. Additionally, for example, the register configuration circuitry 406 determines the value with which to program the register based on register value data received from the memory parsing circuitry 404. Subsequently, the register configuration circuitry 406 communicates a request to the arbitration circuitry 208 of FIG. 2 to program the register with the identified value. As such, the register control circuitry 204 updates, reprograms, and/or otherwise adjusts a register in the reconfigurable circuitry 206 to mitigate an unintended condition in the audio amplifier 100. In some examples, the register configuration circuitry 406 is instantiated by programmable circuitry executing register configuration instructions and/or configured to perform operations such as those represented by the flowchart(s) of FIG. 6.

In some examples, the register control circuitry 204 includes means for configuring registers. For example, the means for configuring registers may be implemented by the register configuration circuitry 406. In some examples, the register configuration circuitry 406 may be instantiated by programmable circuitry such as the example programmable circuitry 712 of FIG. 7. For example, the register configuration circuitry 406 may be instantiated by the example microprocessor 800 of FIG. 8 executing machine-executable instructions such as those implemented by at least block 610 of FIG. 6. In some examples, the register configuration circuitry 406 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the register configuration circuitry 406 may be instantiated by any other combination of hardware, software, and/or firmware. For example, the register configuration circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the register control circuitry 204 of FIG. 2 is illustrated in FIG. 4, one or more of the elements, processes, and/or devices illustrated in FIG. 4 may be combined, divided, re-arranged, omitted, eliminated, and/or implemented in any other way. Further, the example trigger event monitoring circuitry 402, the example memory parsing circuitry 404, the example register configuration circuitry 406, and/or, more generally, the example register control circuitry 204 of FIGS. 2 and/or 4, may be implemented by hardware alone or by hardware in combination with software and/or firmware. Thus, for example, any of the example trigger event monitoring circuitry 402, the example memory parsing circuitry 404, the example register configuration circuitry 406, and/or, more generally, the example register control circuitry 204 of FIGS. 2 and/or 4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example register control circuitry 204 of FIG. 4 may include one or more elements, processes, and/or devices in addition to, or instead of, those illustrated in FIG. 4, and/or may include more than one of any or all of the illustrated elements, processes, and devices.

A flowchart representative of example machine-readable instructions, which may be executed by programmable circuitry to implement and/or instantiate the register control circuitry 204 of FIG. 4 and/or representative of example operations which may be performed by programmable circuitry to implement and/or instantiate the register control circuitry 204 of FIG. 4, is shown in FIG. 6. The machine-readable instructions may be one or more executable programs or portion(s) of one or more executable programs for execution by programmable circuitry such as the programmable circuitry 712 shown in the example programmable circuitry platform 700 described below in connection with FIG. 7 and/or may be one or more function(s) or portion(s) of functions to be performed by the example programmable circuitry (e.g., an FPGA) described below in connection with FIGS. 8 and/or 9. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIG. 6, many other methods of implementing the example register control circuitry 204 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

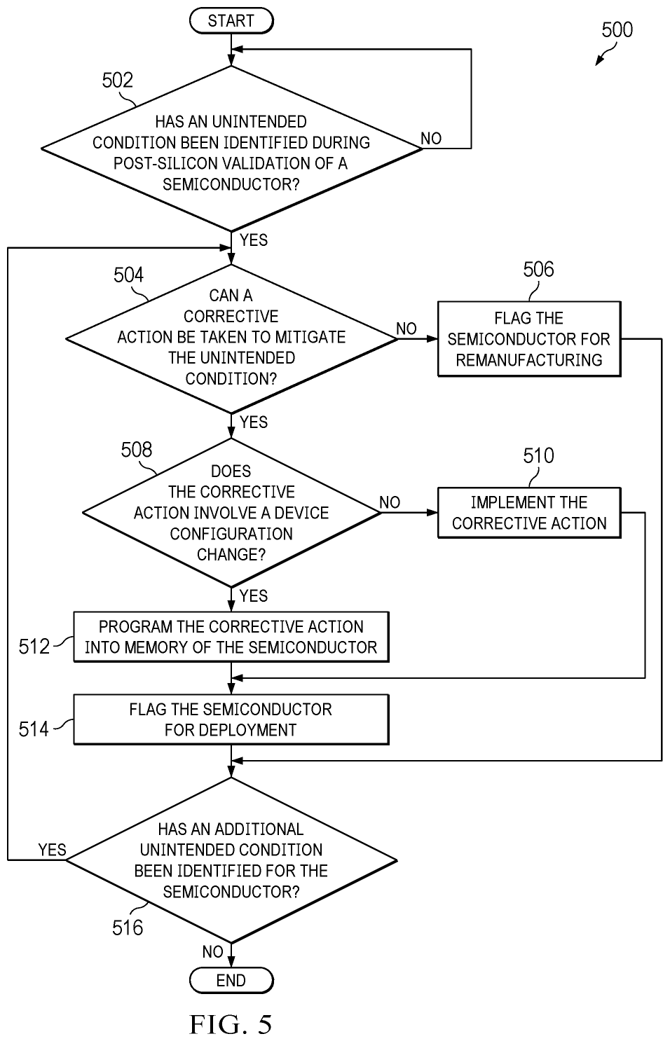

FIG. 5 is a flowchart representative of an example method 500 to troubleshoot semiconductors. The method 500 begins at block 502 where a semiconductor developer determines whether an unintended condition has been identified during post-silicon validation of a semiconductor. At block 504, a semiconductor developer determines whether a corrective action can be taken to mitigate the unintended condition. For example, at block 504, a semiconductor developer can test candidate corrective actions to address the unintended condition and determine whether any of the candidate corrective actions mitigate the unintended condition.

In some examples, the testing involves a semiconductor developer evaluating whether candidate configuration changes to one or more registers of reconfigurable circuitry of the semiconductor mitigate the unintended condition. Based on (e.g., in response to) a semiconductor developer determining that a corrective action cannot be taken to mitigate the unintended condition (block 504: NO), the method 500 proceeds to block 506. Based on (e.g., in response to) a semiconductor developer determining that a corrective action can be taken to mitigate the unintended condition (block 504: YES), the method 500 proceeds to block 508.

In the illustrated example of FIG. 5, at block 506, a semiconductor developer flags the semiconductor for remanufacturing. For example, a semiconductor developer can redefine a pattern for the semiconductor to address the unintended condition and then repattern silicon to generate another instance of the semiconductor. At block 508, a semiconductor developer determines whether the corrective action involves a device configuration change. Based on (e.g., in response to) a semiconductor developer determining that the corrective action does not involve a device configuration change (block 508: NO), the method 500 proceeds to block 510. Based on (e.g., in response to) a semiconductor developer determining that the corrective action involves a device configuration change (block 508: YES), the method 500 proceeds to block 512.

In the illustrated example of FIG. 5, at block 510, a semiconductor developer implements the corrective action (e.g., the non-device configuration change action) to mitigate the unintended condition. At block 512, a semiconductor developer programs the corrective action into memory of the semiconductor. For example, a semiconductor developer programs OTP memory of the semiconductor with reconfiguration data (e.g., register address data, register value data, and trigger event data). Additionally, a semiconductor developer burns the OTP memory. At block 514, a semiconductor developer flags the semiconductor for deployment. As described below in connection with FIG. 6, during deployment a semiconductor including reconfiguration data can take corrective actions to mitigate unintended conditions in the semiconductor.

In the illustrated example of FIG. 5, at block 516, a semiconductor developer determines whether an additional unintended condition has been identified for the semiconductor. Based on (e.g., in response to) a semiconductor developer determining that an additional unintended condition has been identified for the semiconductor (block 516: YES), the method 500 returns to block 504. Based on (e.g., in response to) a semiconductor developer determining that an additional unintended condition has not been identified for the semiconductor (block 516: NO), the method 500 terminates.

In some examples, the method 500 may be performed by an automated system. For example, a semiconductor could be coupled to programmable circuitry executing, instantiating, and/or performing example machine-readable instructions. In such examples, the programmable circuitry tests candidate corrective actions to address an unintended condition in the semiconductor. For example, the programmable circuitry evaluates whether a candidate configuration change mitigates an unintended condition and records whether the candidate configuration change successfully mitigates the unintended condition. Additionally, for example, the programmable circuitry tests whether candidate non-device configuration change corrective actions address the unintended condition.

In examples where programmable circuitry tests candidate corrective actions, if the programmable circuitry does not identify a corrective action that will mitigate the unintended condition, the programmable circuitry flags a semiconductor for remanufacturing. Alternatively, if the programmable circuitry identifies a corrective action that will mitigate the unintended condition, the programmable circuitry implements the corrective action. For example, the programmable circuitry programs OTP memory of the semiconductor with a corrective action. After implementing a corrective action for a semiconductor, the programmable circuitry flags the semiconductor for deployment.

FIG. 6 is a flowchart representative of example machine-readable instructions and/or example operations 600 that may be executed, instantiated, and/or performed using an example programmable circuitry implementation of the register control circuitry 204 of FIGS. 2 and/or 4. The example machine-readable instructions and/or the example operations 600 of FIG. 6 begin at block 602, at which the trigger event monitoring circuitry 402 monitors the FSM circuitry 106 to determine whether the FSM circuitry 106 has experienced (e.g., undergone) a trigger event. In the example of FIG. 6, at block 604, the trigger event monitoring circuitry 402 determines whether the FSM circuitry 106 experienced (e.g., has undergone) a trigger event.

For example, at block 604, the trigger event monitoring circuitry 402 determines whether an interrupt has been received from the FSM circuitry 106 where the interrupt includes a trigger event code. In the event that the trigger event monitoring circuitry 402 determines (e.g., detects) that the FSM circuitry 106 has experienced a trigger event, the trigger event monitoring circuitry 402 notifies the memory parsing circuitry 404 that the FSM circuitry 106 has experienced the trigger event. For example, the trigger event monitoring circuitry 402 extracts a trigger event code from the interrupt and forwards the trigger event code to the memory parsing circuitry 404.

In the illustrated example of FIG. 6, based on (e.g., in response to) the trigger event monitoring circuitry 402 determining that the FSM circuitry 106 has not experienced a trigger event (block 604: NO), the machine-readable instructions and/or the operations 600 return to block 602. Based on (e.g., in response to) the trigger event monitoring circuitry 402 determining that the FSM circuitry 106 has experienced a trigger event (block 604: YES), the machine-readable instructions and/or the operations 600 proceed to block 606. At block 606, the memory parsing circuitry 404 compares a first trigger even code corresponding to the trigger event to one or more trigger event codes included in reconfiguration data stored in the memory 110. For example, at block 606, the memory parsing circuitry 404 parses the memory 110 to determine whether the memory 110 includes a reconfiguration block having a second trigger event code that matches the first trigger event code received from the FSM circuitry 106. In some examples, at block 606, the memory parsing circuitry 404 parses the memory 110 to determine whether the memory 110 includes a trigger event block (e.g., trigger event data) having a trigger event code that matches the trigger event code received from the FSM circuitry 106. As such, at block 606, the memory parsing circuitry 404 determines whether the memory 110 includes reconfiguration data corresponding to the trigger event.

In the illustrated example of FIG. 6, at block 608, the memory parsing circuitry 404 determines whether the memory 110 includes reconfiguration data having the second trigger event code corresponding to (e.g., that matches) the first trigger event code. Based on the memory parsing circuitry 404 determining that the memory 110 includes a reconfiguration block having a second trigger event code that matches the first trigger event code, the memory parsing circuitry 404 determine the register address data and the register value data included in the reconfiguration block. In some examples, based on the memory parsing circuitry 404 determining that the memory 110 includes a trigger event block having a trigger event code that matches the received trigger event code, the memory parsing circuitry 404 determines one or more reconfiguration blocks corresponding to the trigger event code. For example, the number and position of reconfiguration block(s) corresponding to the trigger event code in the memory 110. Additionally, the memory parsing circuitry 404 extracts the register address data and the register value data included in the corresponding reconfiguration block(s). In the example of FIG. 6, the memory parsing circuitry 404 forwards the register address data and register value data to the register configuration circuitry 406.

In the illustrated example of FIG. 6, based on the memory parsing circuitry 404 determining that the memory 110 does not include reconfiguration data having the second trigger event code corresponding to the first trigger event code (block 608: NO), the machine-readable instructions and/or the operations 600 return to block 602. Based on the memory parsing circuitry 404 determining that the memory 110 includes reconfiguration data having the second trigger event code corresponding to the first trigger event code (block 608: YES), the machine-readable instructions and/or the operations 600 proceed to block 610. At block 610, the register configuration circuitry 406 reconfigures a register identified in the reconfiguration data with a value included in the reconfiguration data. For example, at block 610, the register configuration circuitry 406 determines the address of a register that is to be programmed based on register address data received from the memory parsing circuitry 404. Additionally, for example, at block 610, the register configuration circuitry 406 determines the value with which to program the register based on register value data received from the memory parsing circuitry 404. Furthermore, at block 610, the register configuration circuitry 406 communicates a request to the arbitration circuitry 208 of FIG. 2 to program the register with the identified value.

In the illustrated example of FIG. 6, at block 612, the memory parsing circuitry 404 determines whether the memory 110 includes additional reconfiguration data corresponding to the trigger event. Based on (e.g., in response to) the memory parsing circuitry 404 determining that the memory 110 includes additional reconfiguration data corresponding to the trigger event (block 612: YES), the machine-readable instructions and/or the operations 600 return to block 610. Based on (e.g., in response to) the memory parsing circuitry 404 determining that the memory 110 does not include additional reconfiguration data corresponding to the trigger event (block 612: NO), the machine-readable instructions and/or the operations 600 terminate.

As such, examples described herein can achieve complex corrective actions that reduce the probability of requiring repatterning of silicon. For example, one unintended condition in an audio amplifier is that the output of the DAC connected to the amplifier circuitry is not muted during power down of the audio amplifier. As such, an audible sound can be heard during power down of the audio amplifier or during power down for noise gate purposes (e.g., to reduce undesirable output audio). Communication protocol-based scripts cannot address this unintended condition at least because the software driver, which is responsible for communicating the communication protocol-based scripts to the audio amplifier, does not track internal states of the audio amplifier and thus is not aware of when the audio amplifier is powered down (e.g., noise gate power down). Thus, addressing this issue would have required repatterning of silicon.

However, examples described herein advantageously enable FSM circuitry of the audio amplifier to generate a trigger event code at the start of audio amplifier power down which is used by register control circuitry to identify the address of a register and a value with which to program the register to mute the output of the DAC. Accordingly, silicon implementing the audio amplifier would not need to be repatterned. Additionally, at least by avoiding repatterning, examples described herein reduce the monetary cost of development of semiconductors. Furthermore, at least by avoiding repatterning, examples described herein reduce development time of semiconductors.

FIG. 7 is a block diagram of an example programmable circuitry platform 700 structured to execute and/or instantiate the example machine-readable instructions and/or the example operations of FIG. 6 to implement the register control circuitry 204 of FIGS. 2 and/or 4. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example trigger event monitoring circuitry 402, the example memory parsing circuitry 404, the example register configuration circuitry 406, and/or, more generally, the example register control circuitry 204 of FIGS. 2 and/or 4.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUSR Dynamic Random Access Memory (RDRAMR), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth®: interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIG. 6, may be stored in the mass storage device 728, in the volatile memory 714, in the non-volatile memory 716, and/or on at least one non-transitory computer-readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowchart of FIG. 6 to effectively instantiate the circuitry of FIG. 4 as logic circuits to perform operations corresponding to those machine-readable instructions. In some such examples, the circuitry of FIG. 4 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowchart of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry 816 (sometimes referred to as an ALU), a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer-based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowchart of FIG. 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine-readable instructions represented by the flowchart of FIG. 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 6. As such, the FPGA circuitry 900 may be configured and/or structured to effectively instantiate some or all of the operations/functions corresponding to the machine-readable instructions of the flowchart of FIG. 6 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIG. 6 faster than the general-purpose microprocessor can execute the same.

In the example of FIG. 9, the FPGA circuitry 900 is configured and/or structured in response to being programmed (and/or reprogrammed one or more times) based on a binary file, In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL: the code/program may be translated into a low-level language as needed: and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIG. 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowchart of FIG. 6 to perform first operation(s)/function(s), the FPGA circuitry 900 of FIG. 9 may be configured and/or structured to perform second operation(s)/function(s) corresponding to a second portion of the machine-readable instructions represented by the flowchart of FIG. 6, and/or an ASIC may be configured and/or structured to perform third operation(s)/function(s) corresponding to a third portion of the machine-readable instructions represented by the flowchart of FIG. 6.

It should be understood that some or all of the circuitry of FIG. 4 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 800 of FIG. 8 may execute machine-readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 4 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

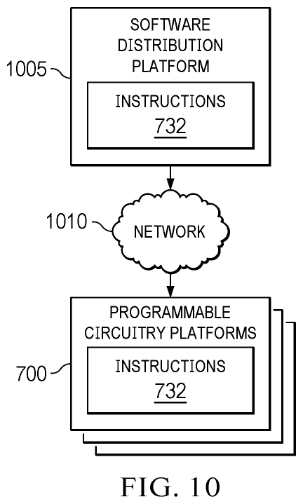

A block diagram illustrating an example software distribution platform 1005 to distribute software such as the example machine-readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine-readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine-readable instructions 732, which may correspond to the example machine-readable instructions of FIG. 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 732 from the software distribution platform 1005. For example, the software, which may correspond to the example machine-readable instructions of FIG. 6, may be downloaded to the example programmable circuitry platform 700, which is to execute the machine-readable instructions 732 to implement the register control circuitry 204. In some examples, one or more servers of the software distribution platform 1005 periodically offer, transmit, and/or force updates to the software (e.g., the example machine-readable instructions 732 of FIG. 7) to ensure improvements, patches, updates, etc., are distributed and applied to the software at the end user devices. Although referred to as software above, the distributed “software” could alternatively be firmware.

In this description, the term “and/or” (when used in a form such as A, B and/or C) refers to any combination or subset of A, B, C, such as: (a) A alone: (b) B alone: (c) C alone: (d) A with B: (e) A with C: (f) B with C: and (g) A with B and with C. Also, as used herein, the phrase “at least one of A or B” (or “at least one of A and B”) refers to implementations including any of: (a) at least one A: (b) at least one B: and (c) at least one A and at least one B.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

Numerical identifiers such as “first,” “second,” “third,” etc. are used merely to distinguish between elements of substantially the same type in terms of structure and/or function. These identifiers, as used in the detailed description, do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate: (ii) incorporated in a single semiconductor package: (iii) incorporated into the same module: and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that facilitate deployment of complex workarounds to address unintended conditions in semiconductor devices. Such complex workarounds would not otherwise be possible without examples described herein. Thus, examples described herein avoid remanufacturing of a semiconductor device when a complicated workaround is required to address an unintended condition in the semiconductor device. Additionally, in part because examples described herein do not require communication protocol-based scripts to be integrated into a software driver for a semiconductor device, examples described herein simplify software driver development. Described systems, apparatus, articles of manufacture, and methods improve the efficiency of using a computing device by mitigating unintended conditions in semiconductors at predefined trigger events. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

1. An apparatus comprising:
a register;
a memory to store reconfiguration data associated with the register; and
register control circuitry to:
determine whether the memory includes the reconfiguration data corresponding to a trigger event experienced by state machine circuitry; and
based on determining that the memory includes the reconfiguration data corresponding to the trigger event, reconfigure the register identified in the reconfiguration data with a value included in the reconfiguration data.

2. The apparatus of claim 1, wherein the register control circuitry is to determine whether the state machine circuitry experienced the trigger event based on whether an interrupt from the state machine circuitry includes a trigger event code.

3. The apparatus of claim 1, wherein the trigger event is a first trigger event, the memory includes trigger event data, and the register control circuitry is to, based on the state machine circuitry experiencing the first trigger event:
compare a first trigger event code corresponding to the first trigger event to a second trigger event code included in the trigger event data; and
based on the first trigger event code matching the second trigger event code, determine the reconfiguration data corresponding to the second trigger event code to determine the reconfiguration data corresponding to the first trigger event.

4. The apparatus of claim 1, wherein the reconfiguration data is to identify an address of the register and the value with which to program the register.

5. The apparatus of claim 4, wherein the memory includes trigger event data, the trigger event data to identify the trigger event after which to program the register.

6. The apparatus of claim 1, further including the state machine circuitry, the state machine circuitry to generate an interrupt after experiencing the trigger event.

7. The apparatus of claim 1, further including:
communication protocol circuitry; and
arbitration circuitry to resolve a conflict between a first communication from the register control circuitry and a second communication from the communication protocol circuitry.

8. An apparatus comprising:
reconfigurable circuitry;
a memory to store reconfiguration data associated with the reconfigurable circuitry; and
control circuitry to:
determine whether the memory includes the reconfiguration data corresponding to a trigger event experienced by state machine circuitry; and
based on determining that the memory includes the reconfiguration data corresponding to the trigger event, reconfigure the reconfigurable circuitry identified in the reconfiguration data with a value included in the reconfiguration data.

9. The apparatus of claim 8, wherein the control circuitry is to determine whether the state machine circuitry experienced the trigger event based on whether an interrupt from the state machine circuitry includes a trigger event code.

10. The apparatus of claim 8, wherein the trigger event is a first trigger event, the memory includes trigger event data, and the control circuitry is to, based on the state machine circuitry experiencing the first trigger event:
compare a first trigger event code corresponding to the first trigger event to a second trigger event code included in the trigger event data; and
based on the first trigger event code matching the second trigger event code, determine the reconfiguration data corresponding to the second trigger event code to determine the reconfiguration data corresponding to the first trigger event.

11. The apparatus of claim 8, wherein the memory is first memory, and the reconfigurable circuitry includes at least one of a first register, second memory, a first variable component including a second register, or a second variable component including switching circuitry.

12. The apparatus of claim 11, wherein the reconfiguration data is to identify an address of the register and the value with which to program the register.

13. The apparatus of claim 8, further including the state machine circuitry, the state machine circuitry to generate an interrupt after experiencing the trigger event.

14. The apparatus of claim 8, further including:
communication protocol circuitry; and
arbitration circuitry to resolve a conflict between a first communication from the control circuitry and a second communication from the communication protocol circuitry.

15. A method comprising:
determining, with control circuitry, whether memory includes reconfiguration data corresponding to a trigger event experienced by state machine circuitry; and
based on determining that the memory includes the reconfiguration data corresponding to the trigger event, reconfiguring, with the control circuitry, reconfigurable circuitry identified in the reconfiguration data with a value included in the reconfiguration data.

16. The method of claim 15, further including determining whether the state machine circuitry experienced the trigger event based on whether an interrupt from the state machine circuitry includes a trigger event code.

17. The method of claim 15, wherein the trigger event is a first trigger event, the memory includes trigger event data, and the method further includes, based on the state machine circuitry experiencing the first trigger event:
comparing a first trigger event code corresponding to the first trigger event to a second trigger event code included in the trigger event data; and
based on the first trigger event code matching the second trigger event code, determining the reconfiguration data corresponding to the second trigger event code to determine the reconfiguration data corresponding to the first trigger event.

18. The method of claim 15, wherein the memory is first memory, and the reconfigurable circuitry includes at least one of a first register, second memory, a first variable component including a second register, or a second variable component including switching circuitry.

19. The method of claim 18, wherein the reconfiguration data is to identify an address of the register and the value with which to program the register.

20. The method of claim 19, wherein the memory includes trigger event data, the trigger event data to identify the trigger event after which to program the register.

21.-27. (canceled)
